(19) United States
(12) Patent Application Publication
(10) Pub. No.: US 2023/0123979 A1
(43) Pub. Date: Apr. 20, 2023

(54) SYSTEMS AND METHODS FOR SENDING CLAIM STATUS REQUESTS

(71) Applicant: Change Healthcare Holdings, LLC, Nashville, TN (US)

(72) Inventor: John B. Ulam, Cumming, GA (US)

(21) Appl. No.: 17/504,692

(22) Filed: Oct. 19, 2021

(51) Int. Cl. G06Q 40/08

(52) U.S. Cl. CPC G06Q 40/08

(57) ABSTRACT

In an embodiment, a smart claims status request system is provided. The system may be part of a medical claims clearinghouse where medical requests are received from medical providers for a plurality of payors. For each claim, statistics are collected such as the payor associated with the claim, the amount of time that the claim took to be processed by the payor, the amount of the claim, the medical provider associated with the claim, and the particular medical services associated with the claim. Based on the collected statistics, when a new claim is received by the clearing house, an expected handling time for the claim is determined. If the claim is not handled after the expected handling time, the system automatically sends a status request to the payor.

### BACKGROUND

In a medical claims processing system, medical claims are received by the system from one or more medical providers. The claims may include insurance claims for one or more payors such as insurance companies or the government. The system may perform an initial syntax or validity check on each received claim and may send valid and correct claims to their associated payor for fulfillment.

As may be appreciated, each payor may take a varying amount of time to either accept or reject each medical claim. Payors understand that providers want to have their medical claims approved or paid as soon as possible and provide a mechanism for the medical providers to request and receive status updates. While this effective at alleviating some concerns of medical providers, requesting status updates can be a time consuming process for medical providers. In addition, responding to such status requests by payors is also time consuming, especially for medical claims where the status requests are premature.

### SUMMARY

In an embodiment, a smart claims status request system is provided. The system may be part of a medical claims clearinghouse where medical requests are received from medical providers for a plurality of payors. For each claim, statistics are collected such as the payor associated with the claim, the amount of time that the claim took to be processed by the payor, the amount of the claim, the medical provider associated with the claim, and the particular medical services associated with the claim. Based on the collected statistics, when a new claim is received by the clearing house, an expected handling time for the claim is determined. If the claim is not handled after the expected handling time, the system automatically sends a status request to the payor.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate a smart claims status request system and method. Together with the description, the figures further serve to explain the principles of the smart claims status request system and method described herein and thereby enable a person skilled in the pertinent art to make and use the smart claims status request system and method.

FIG. 1 is an example environment for generating and sending status requests for submitted claims;

FIG. 2 is an illustration of an example method for generating handling statistics for payors;

FIG. 3 is an illustration of an example method for estimating a handling date for a claim and for sending a status request based on the estimated handling date; and

FIG. 4 shows an exemplary computing environment in which example embodiments and aspects may be implemented.

### DETAILED DESCRIPTION

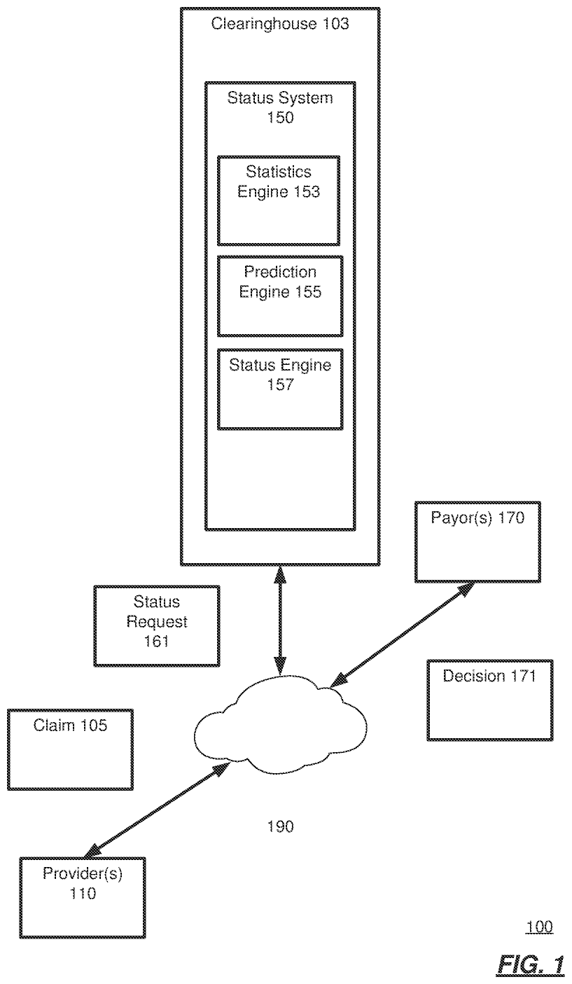

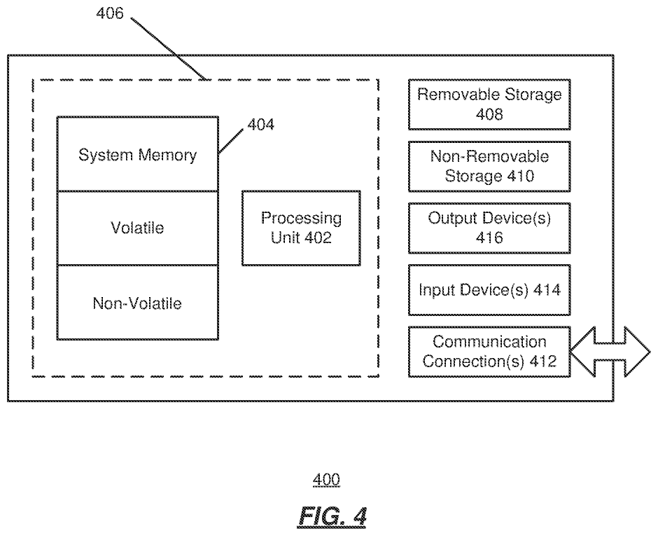

FIG. 1 is an example cloud computing environment 100 for generating and sending status requests for submitted claims. As shown, the environment 100 includes a clearinghouse 103 that interacts with one or more providers 110 and payors 170 through a network 190. The network 190 may include a combination of public and private networks. Each of the clearinghouse 103, providers 110, and payors 170 may be implemented using one or more general purpose computing devices such as the computing device 400 illustrated with respect to FIG. 4.

The clearinghouse 103 may receive claims 105 from a variety of providers 110 through the network 190. The claims 105 may be medical claims and may be requests for reimbursement for medical services (e.g., medical exams, surgeries, tests, and imaging) and medications. The providers 110 may include any provider of medical services or medications such as doctors, hospitals, clinics, and pharmacies, for example.

Because of the complexities associated with submitting medical claims 105, rather than submitting the claims 105 directly to an associated payor 170, the providers 110 may provide the claims 105 to the clearinghouse 103. The clearinghouse 103 may validate the received claims 105, may convert the claims 105 into the format or batch preferred by the payor 170, and may provide the claims to the payor 170 through the network 190. The clearinghouse 103 may further provide the providers 110 and payors 170 an interface through which they can view their outstanding or completed claims 105. The payors 170 may include any payor of a medical claim such as an insurance company or government entity, for example.

In general, when a payor 170 receives a claim 105 from a provider 110 via the clearinghouse 103, the payor 170 may process the claim 105, and may generate a decision 171. The decision 171 may include a denial of the claim 105, an approval of the claim 105, or a partial approval of the claim 105. Depending on the embodiment, the decision 171 may indicate an amount of money that the payor 170 will pay for the claim 105. The clearinghouse 103 may then provide the decision 171 to the provider 110 and may even facilitate payment to the provider 110 based on the decision 171. The steps of the payor 170 receiving a claim 105 and generating a decision 171 is referred to herein as handling the claim 105.

As described above, the time it takes for a payor 170 to handle a claim 105 can vary based on a variety of factors such as the internal procedures of the payor 170, the amount of money associated with the claim 105, the medical provider 110, and the particular procedures or medications associated with the claim 105. At the same time, when a provider 110 is waiting for a claim 105 to be handled, the provider 110 may generate a status request 161 asking for an update on where the submitted claim 105 stands in the fulfillment process. The status requests 161 may be electronic messages that are generated by the clearinghouse 103 on behalf of the providers 110 and sent to the associated payors 170 through the network 190.

When a status request 161 is received by the payor 170, the payor 170 may determine the status of the claim 105. Sometimes, the payor 170 may determine that the claim 105 is still being processed and may respond to the request 161 with that information. Other times, the the payor 170 may determine that the claim 105 has been lost or otherwise held up and may expedite the processing of the claim 105.

While status requests 161 are useful, there are many drawbacks associated with such requests, especially when they are generated early or prematurely. Providers 110 must use resources to track their claims 105, determine when a status request 161 should be sent, and send the status request 161. The payors 170 in turn must use resources to receive and respond to such requests 161. When a status request 161 is received for a claim 105 that is undergoing normal processing (i.e., is not late or otherwise delayed), there is no benefit in the status request 161. Accordingly, there is a need to reduce the number of premature status requests 161 that are generated by providers 110 and to reduce the overall costs of such requests in both time and resources.

In order to solve the problems noted above and others, the clearinghouse 103 may further include a status system 150. The status system 150 may be a smart system that tracks the claims 105 that have been submitted by providers 110 for payors 170, and may predict, for each claim 105, a date when a decision 171 is likely to received from the payor 170 (i.e., when the claim 105 will be handled). If the date is exceeded for a claim 105, the clearinghouse 103 may automatically generate a status request 161 for the provider 110.

The status system 150 described herein provides may advantages. First, because requests 161 are sent only after a determination is made that the decision 171 is likely late, the handing of premature status requests 161 is reduced for payors 170. Second, because the system 150 generates status requests 161 automatically and without provider 110 input, the costs of tracking claims 105 and sending status requests 161 by providers 110 is greatly reduced.

As shown, the status system 150 may include several components including, but not limited to, a statistics engine 153, a prediction engine 155, and a status engine 157. More or fewer components may be supported. The various components of the status system 150 may be implemented together or separately using one or more general purpose computing devices such as the computing device 400 illustrated with respect to FIG. 4.

The statistics engine 153 may track and collect statistics about the claims 105 submitted by the providers 110 for each of the payors 170. One example statistic collected by the statistics engine 150 for a payor 170 is referred to herein as average handling time. The average handling time for a payor 170 may be average amount of time that it takes the payor 170 to handle a claim 105. Depending on the embodiment, the handling time for a claim may be measured from when the payor 170 acknowledges receipt of the claim 105 to when the decision 171 is generated. As may be appreciated each payor 170 may have a different average handling time.

In some embodiments, the statistics engine 153 may calculate average handling time for a payor 170 using all of the claims 105 for that payor. In other embodiments, the statistics engine 153 may track additional attributes about each claim 105 that may be useful for calculating the handling time for the claims 105. These attributes may include, but are not limited to, the particular medical procedure associated with a claim 105 (e.g., certain medical procedures may be associated with fraud or abuse and may receive extra scrutiny by a payor 170), the medication associated with a claim 105 (e.g., certain medications that are rare, expensive, or subject to abuse may receive extra scrutiny by a payor 170), the overall cost of the claim 105 (e.g., more expensive claims 105 may receive extra scrutiny by a payor 170), and the provider 110 that submits the claim 105 (e.g., some providers 110 may receive extra scrutiny because of past misconduct by the provider 110 or an experience level of the providers 110). Other information may be considered such as the date when the claim 105 was submitted (e.g., some times of the year may be busier and may result in increased handling time for claims 105).

The statistics engine 153, for each payor 170, may generate multiple average handling times for the payor 170. Each average handling time may be for claims 105 that have different combinations of the above described claim 105 attributes that may be tracked by the statistics engine 153.

In some embodiments, rather than generate multiple average handling times for different combinations of claim 105 attributes, the statistics engine 153 may train a model that is predictive of the handling time for a received claim 105. The model may receive as an input attributes of a claim 105 such as the payor 170 associated with the claim 105, the provider 110 associated with the claim 105, the particular procedures or medications associated with the claim 105, the cost of the claim 105, and the date of the claim 105. Other attributes may be supported. The model may then output an expected amount of time that the claim 105 will take to handle. Any method for training a machine learning model may be used. In addition, the statistics engine 153 may track the overall accuracy of the predictions made by the model for each claim 105 and may provide positive or negative feedback to the model based on the accuracy.

The prediction engine 155 may determine the expected handling time for a received claim 105 and may record a date when a decision 171 is expected from the payor 170 based on the expected handling time. In some embodiments, when a claim 105 is received, the prediction engine 155 may use the average handling time for the payor 170 determined by the statistics engine 153. Where multiple claim 105 attributes are considered, the prediction engine 155 may select the average handling time for the payor 170 that best matches the attributes of the claim 105. In embodiments using a prediction model, the prediction engine 155 may feed the attributes of the claim 105 to the model and may receive the average or expected handling time for the claim 105 from the model.

The status engine 157 may, for each received claim 105, track the expected handling date for that claim 105. If the expected handling date has past (i.e., a current date is past the expected date), then the status engine 157 may generate a status request 161 for the claim 105 and may automatically (e.g., without action from the provider 110) send the status request 161 to the payor 170 associated with the claim 105. The status engine 157 may then mark the claim 105 as having an outstanding status request 161 so that no additional status requests 161 are sent. In addition, the status engine 157 may send a message to the associated provider 110 indicating that the status request 161 was sent.

In some embodiments, the status engine 157 may allow each provider 110 to customize how status requests 161 are handled for the provider 110. One such option is the ability for a provider to either enable or disable the automatic sending of status requests 161 for claims 105 associated with the provider 110. For example, the provider 110 may be able to disable (or enable) automatic status requests 161 on a per claim 105 basis, or across all claims 105 associated with the provider 105. Other options may include only sending status requests 161 for claims 105 associated with certain payor 170, or having certain attributes (e.g., greater than a threshold cost), or how long to wait before sending a request 161 (e.g., how many days after the expected handling time has expired).

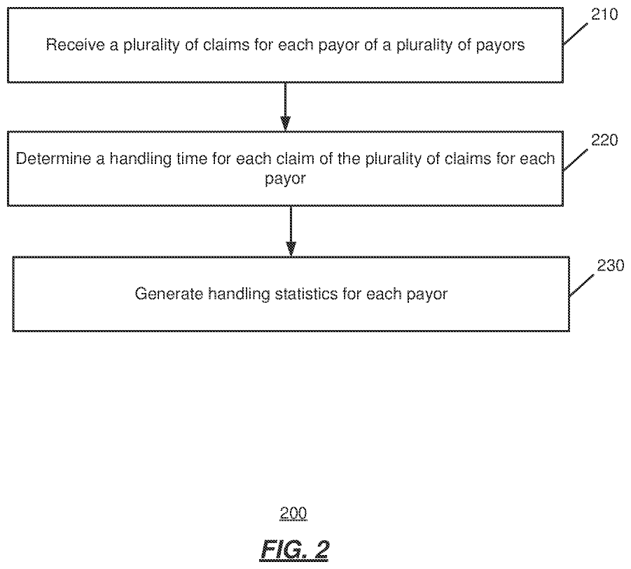

FIG. 2 is an illustration of an example method for generating handling statistics for payors. The method 200 may be implemented by the status system 150.

At 210, a plurality of claims is received. A plurality of claims 105 may be received by the statistics engine 153 for each payor 170 of a plurality of payors 170. The claims 105 may have been previously received and handled by the clearinghouse 103. Each claim 105 may be associated with a plurality of attributes that identify the payor 170 associated with the claim 105, the provider 110 associated with the claim 105, the medical procedure or medication associated with the claim 105, the date when the claim 105 was submitted, and the date when the claim 105 was handled.

At 220, a handling time is determined for each claim of the plurality of claims. The handling time may be determined by the statistics engine 153. In some embodiments, the handling time for a claim 105 may be determined based on the difference between when the claim 105 was submitted and when the claim 105 was handled.

At 230, handling statistics are generated for each payor. The handling statistics for a payor 170 may be generated by the statistics engine 153 using the claims 105 associated with the payor 170. One example handling statistic generated for the payor 170 is average handling time. The average handling time may be calculated for a payor 170 using all of the claims 105 associated with the payor 170. Alternatively, different average handling times may be determined for different combination of claim 105 attributes. Any combination of claim 105 attributes may be supported.

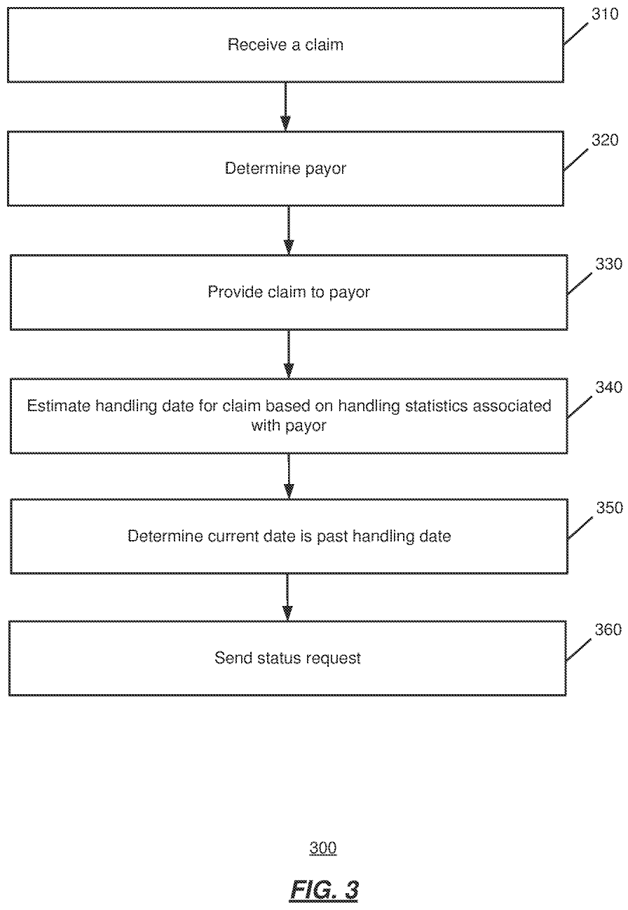

FIG. 3 is an illustration of an example method for estimating a handling date for a claim and for sending a status request based on the estimated handling date. The method 300 may be implemented by the status system 150.

At 310, a claim is received. The claim 105 may be received by a prediction engine 155 of the status system 150 from a provider 110. The claim 105 may have been provided to a clearinghouse 103 that the status system 150 is part of. The claim 105 may be a medical claim 105 and may be directed to a payor 170. The claim 105 may have one or more attributes such as an amount and the particular medical procedures or medications associated with the claim 105. The claim 105 may be received by the prediction engine 155 after having been validated by the clearinghouse 103 for the provider 110.

At 320, a payor is determined. The payor is determined by the prediction engine 155 based on the attributes associated with the claim 105 and/or information provided by the clearinghouse 103.

At 330, the claim is provided to the payor. The claim 105 may be provided to the payor 170 through the network 190 by the status system 150 or the clearinghouse 103. After the payor 170 acknowledges receipt of the claim 105, the status system 150 may record the claim 105 as provided to the payor 170.

At 340, a handling date is estimated. A handling date for the claim 105 may be estimated by the prediction engine 155 using statistics associated with the payor 170 collected by the statistics engine 153. In some embodiments, the handling date may be estimated based on an average handling time determined for the payor 170 by the statistics engine 153 and the date that the claim 105 was acknowledged by the payor 170. The average handling time may be based on all claims 105 handled by the payor 170 or on those claims 105 with similar attributes as the received claim.

At 350, that the current date is past the handling date is determined. The determination may be made by the status engine 157. For example, the status engine 157 may periodically compare the stored estimated handling date for claims 105 to a current date.

At 360, a status request is sent. The status request 161 may be sent by the status engine 157 to the payor 170 associated with the received claim 105 in response to determining that the current date is past the handling date estimated for the claims.

FIG. 4 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a claim by a computing device, wherein the claim is received from provider of a plurality of providers;
determining a payor associated with the claim by the the computing device;
providing the claim to the payor by the computing device;
based on statistics associated with the payor, estimating a date when the payor will handle the claim by the computing device;
determining that a current date is later than the estimated date and that the payor has not handled the claim by the computing device; and
in response to the determination, sending a status request for the claim to the payor by the computing device.

2. The method of claim 1, wherein the claim is a medical claim.

3. The method of claim 1, further comprising:
determining an amount associated with claim; and
based on the statistics associated with the payor and the determined amount, estimating the date when the payor will handle the claim.

4. The method of claim 1, further comprising:
determining a medical procedure associated with claim; and
based on the statistics associated with the payor and the medical procedure, estimating the date when the payor will handle the claim.

5. The method of claim 1, further comprising:
determining a medication associated with claim; and
based on the statistics associated with the payor and the medication, estimating the date when the payor will handle the claim.

6. The method of claim 1, wherein sending the status request comprises sending the status request automatically and without receiving instructions from the provider.

7. The method of claim 1, wherein the statistics associated with the payor comprise an average handling time for each claim.

8. The method of claim 1, further comprising:
receiving a plurality of claims for the payor;
determining a handling time for each claim of the plurality of claims; and
generating the statistics based on the determined handling time for each claim of the plurality of claims.

9. A method comprising:
receiving a plurality of claims for each payor of a plurality of payors by a computing device;
for each payor of the plurality of payors, determining a handling time for each claim of the plurality of claims associated with the payor by the computing device; and
for each payor of the plurality of payors, generating statistics for the payor based on the determined handling time for each claim of the plurality of claims associated with the payor by the computing device.

10. The method of claim 8, further comprising:
receiving a new claim from a provider;
determining a payor of the plurality of payors associated with the new claim;
providing the new claim to the determined payor;
based on generated statistics associated with the determined payor, estimating a date when the determined payor will handle the new claim;
determining that a current date is later than the estimated date and that the determined payor has not handled the new claim; and
in response to the determination, sending a status request for the claim to the determined payor.

11. The method of claim 10, wherein the new claim is a medical claim.

12. The method of claim 10, further comprising:
determining an amount associated with new claim; and
based on the generated statistics associated with the determined payor and the determined amount, estimating the date when the determined payor will handle the new claim.

13. The method of claim 10, further comprising:
determining a medical procedure associated with the new claim; and
based on the generated statistics associated with the determined payor and the medical procedure, estimating the date when the determined payor will handle the new claim.

14. The method of claim 10, further comprising:
determining a medication associated with the new claim; and
based on the statistics associated with the determined payor and the medication, estimating the date when the determined payor will handle the new claim.

15. The method of claim 10, wherein sending the status request comprises sending the status request automatically and without receiving instructions from the provider.

16. The method of claim 10, wherein provider is a medical provider and the claim is a medical claim.

17. A system comprising:
at least one computing device; and
a non-transitory computer-readable medium storing instructions thereon that when executed by the at least one computing device cause the at least one computing device to:
receive a claim, wherein the claim is received from provider of a plurality of providers;
determine a payor associated with the claim;
provide the claim to the payor;
based on statistics associated with the payor, estimate a date when the payor will handle the claim;
determine that a current date is later than the estimated date and that the payor has not handled the claim; and
in response to the determination, send a status request for the claim to the payor by the computing device.

18. The system of claim 17, wherein the claim is a medical claim.

19. The system of claim 17, further comprising instructions that when executed by the at least one computing device cause the at least one computing device to:
determine an amount associated with claim; and
based on the statistics associated with the payor and the determined amount, estimate the date when the payor will handle the claim.

20. The system of claim 17, further comprising instructions that when executed by the at least one computing device cause the at least one computing device to:
determine a medical procedure associated with claim; and
based on the statistics associated with the payor and the medical procedure, estimate the date when the payor will handle the claim.
